(19) United States
(12) Patent Application Publication
(10) Pub. No.: US 2010/0004759 A1
(43) Pub. Date: Jan. 7, 2010

(54) METHODS AND APPARATUS TO MANAGE PROCESS PLANT ALARMS

(76) Inventors: Cindy Alsup Scott, Georgetown, TX (US); Robert Burke Havekost, Elgin, TX (US); Michael George Ott, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/560,001

(22) Filed: Sep. 15, 2009

Related U.S. Application Data
(63) Continuation of application No. 11/733,563, filed on Apr. 10, 2007.

(51) Int. Cl. G05B 11/01

(52) U.S. Cl. 700/12

(57) ABSTRACT

Example methods and apparatus to manage process plant alarms are disclosed. A disclosed example method includes receiving a process plant control system configuration parameter, the process plant control system configuration parameter representing a selected state of a process plant, performing a first query in an alarm definition data structure based on the process plant control system configuration parameter to obtain an alarm configuration parameter for a process plant alarm module of a process plant controller, and configuring a state of the process plant alarm module based on the obtained alarm configuration parameter.

### RELATED APPLICATION

This patent arises from a continuation of U.S. patent application Ser. No. 11/733,563, entitled “Methods and Apparatus To Manage Process Plant Alarms,” and filed on Apr. 10, 2007, which is hereby incorporated by reference in its entirety.

### FIELD OF THE DISCLOSURE

This disclosure relates generally to process plants and, more particularly, to methods and apparatus to manage process plant alarms.

### BACKGROUND

Distributed process control systems, like those used in chemical, petroleum and/or other processes, systems, and/or process plants typically include one or more process controllers communicatively coupled to one or more field devices via any of a variety of analog, digital and/or combined analog/digital buses. In such systems and/or processes, field devices including, for example, valves, valve positioners, switches and/or transmitters (e.g., temperature, pressure, level and flow rate sensors), are located within the process environment and perform process control, alarm and/or management functions such as opening or closing valves, measuring process parameters, etc. Process controllers, which may also be located within the plant environment, receive signals indicative of process measurements made by the field devices and/or other information pertaining to the field devices. Based on, for example, the received signals, the process controllers execute a controller application to realize any number and/or type(s) of control modules, routines and/or software threads to initiate alarms, make process control decisions, generate control signals, and/or coordinate with other control modules and/or function blocks performed by field devices, such as HART and Fieldbus field devices. The control modules in the controller(s) send the control signals over the communication lines to the field devices to control the operation of the process plant.

Information from the field devices and/or the controller is usually made available over a data highway or communication network to one or more other hardware devices, such as operator workstations, personal computers, data historians, report generators, centralized databases, etc. Such devices are typically located in control rooms and/or other locations remotely situated relative to the harsher plant environment. These hardware devices, for example, run applications that enable an operator to perform any of a variety of functions with respect to the process(es) of a process plant, such as changing an operating state, changing settings of the process control routine(s), modifying the operation of the control modules within the process controllers and/or the field devices, viewing the current state of the process(es), viewing alarms generated by field devices and/or process controllers, simulating the operation of the process(es) for the purpose of training personnel and/or testing the process control software, keeping and/or updating a configuration database, etc.

As an example, the DeltaV™ control system sold by Fisher-Rosemount Systems, Inc., an Emerson Process Management company, supports multiple applications stored within and/or executed by different devices located at potentially diverse locations within a process plant. A configuration application, which resides in and/or is executed by one or more operator workstations, enables users to create and/or change process control modules, and/or download process control modules via a data highway or communication network to dedicated distributed controllers. Typically, these control modules are made up of communicatively coupled and/or interconnected function blocks that perform functions within the control scheme (e.g., process control and/or alarm generation) based on received inputs and/or that provide outputs to other function blocks within the control scheme. The configuration application may also allow a configuration engineer and/or operator to create and/or change operator interfaces which are used, for example, by a viewing application to display data for an operator and/or to enable the operator to change settings, such as set points and/or operating states, within the process control routines. Each dedicated controller and, in some cases, field devices, stores and/or executes a controller application that runs the control modules assigned to implement actual process control functionality.

The engineer can also create one or more displays for operators, maintenance personnel, etc. of the process plant by selecting and/or building display objects using, for example, a display creation application. These displays are typically implemented on a system-wide basis via one or more of the workstations, and provide preconfigured displays to the operator or maintenance persons regarding the operating state(s) of the control system(s) and/or the devices within the plant. Example displays take the form of alarming displays that receive and/or display alarms generated by controllers or devices within the process plant, control displays that indicate the operating state(s) of the controller(s) and other device(s) within the process plant, maintenance displays that indicate the functional state of the device(s) and/or equipment within the process plant, etc.

In a process control system it is common for thousands of alarms to be defined within the process control system to notify operators of the process plant of potential problems. Alarms are defined, for example, to protect people and/or equipment, to avoid environmental incidents, and/or to ensure product quality during production. Each alarm is typically defined by one or more settings (e.g., an alarm limit) that define when a problem has occurred and/or trigger the alarm, and a priority (e.g., critical or warning) to define the importance of the alarm relative to other alarms. Generally, alarm settings and/or priorities are rigorously set, determined, and/or calculated for a nominal operating state such as, for example, when the process plant is producing product. However, there may be other alternative, defined and/or known operating states of the process plant (e.g., shut-down, maintenance, etc.). However, the alarm settings and/or priorities are commonly defined for the nominal state and, as a result, when the process plant is in an alternative operating state an excessive number of alarms may be created that have little and/or no meaning or value in the alternative operating state.

### SUMMARY

Methods and apparatus to manage process plant alarms are disclosed. Process plant alarms are managed as the operating state(s) of a process plant and/or portions of the process plant are changed. To facilitate the management of process plant alarms, one or more alarm behavior data structures (e.g., tables) are implemented to define alarm states and/or alarm parameters based on operating states, alarm functions and/or alarm priorities. When an operating state change occurs, a control module and/or smart field device accesses the alarm behavior data structures (e.g., performs one or more table lookups) to determine an alarm state for an alarm and then configures the handling of the alarm based upon the alarm state. The control module and/or the smart field device may also perform one or more additional data structure access(es) to obtain one or more alarm parameters that the control module and/or smart field device then uses when configuring the alarm. By using such alarm behavior data structures, alarms can be managed by the control modules and/or the smart field devices without explicit alarm handling routines being written for each control module, smart field device and/or for each operating state. That is, the handling of alarms is defined separately from the control modules, even though the control modules remain responsible for implementing and/or processing their alarms.

A disclosed example method includes performing a first data structure query to obtain an alarm state for a process plant alarm based on a process plant operating state, and configuring handling of the process plant alarm based on the obtained alarm state. The example method may further include performing a second data structure query to obtain an alarm state behavior for the obtained alarm state, wherein configuring the handling of the process plant alarm based on the obtained alarm state includes configuring the handling of the process plant alarm based on the obtained alarm state behavior. Further still, the example method may include performing a third data structure query to obtain an alarm parameter, wherein configuring the handling of the process plant alarm based on the obtained alarm state includes configuring the process plant alarm based upon the obtained alarm state behavior and the obtained alarm parameter.

A disclosed example apparatus includes a machine accessible memory and an alarm behavior rules data structure stored on the machine accessible memory. The alarm behavior rules data structure defining, for a process plant alarm, a plurality of alarm states for respective ones of a plurality of operating states. The example apparatus also includes an alarm manager to receive an operating state selection, to obtain an alarm state from the alarm behavior rules data structure based on the received operating state selection, and to configure handling of the alarm based on the obtained alarm state. The example apparatus may further include an alarm state definitions data structure, the alarm state definitions data structure defining a plurality of alarm handling behaviors for respective ones of a plurality of alarm states. The alarm manager is to obtain an alarm handling behavior from the alarm state definitions data structure based on the obtained alarm state and to configure the handling of the alarm based upon the obtained alarm handling behavior. Additionally or alternatively, the example apparatus may further include an alarm parameter data structure, the alarm parameter data structure defining an alarm parameter for an alarm state, and a function block to receive the operating state selection, to obtain the alarm parameter from the alarm parameter data structure based on the received operating state selection, and to configure the process plant alarm with the alarm parameter

A disclosed example configuration system to configure a process plant includes a processor, and machine accessible instructions which, when executed, cause the processor to present a first user interface to define a plurality of alarm state definitions for a plurality of alarm states, and present a second user interface to associate an alarm state with each of a plurality of combinations of operating states and alarm functions. The processor may also present a third user interface to configure alarm parameters for one or more of the plurality of combinations of operating states and alarm functions.

### BRIEF DESCRIPTION OF THE DRAWINGS

FIG. 1 is a schematic illustration of an example process plant constructed in accordance with the teachings of the invention.

FIG. 2 illustrates an example manner of implementing any or all of the example control modules of FIG. 1.

FIG. 3 illustrates an example data structure that may be used to implement the example alarm state definitions of FIG. 2.

FIG. 4 illustrates an example user interface that may be used to configure an alarm function for a process plant alarm.

FIG. 5 illustrates an example user interface that may be used to enable and/or select alarm behavior rules.

FIG. 6 illustrates an example data structure that may be used to implement the example alarm behavior rules of FIG. 2.

FIG. 7 illustrates an example data structure that may be used to implement the example alarm parameter values of FIG. 2.

FIG. 8 illustrates example user interfaces that may be used to view and/or configure alarm behavior rules and/or alarm parameter values.

FIGS. 9A, 9B, 9C and 9D illustrate example operations of the example parameter setting function block of FIG. 2.

FIGS. 10A and 10B illustrate example alarm management operations for the example process plant of FIG. 1.

FIG. 11 illustrates another example manner of implementing any or all of the example control modules of FIG. 1.

FIG. 12 is a flowchart representative of example process that may be carried out to implement the example alarm manager of FIG. 2 and/or, more generally, to implement any or all of the example control modules of FIG. 1.

FIG. 13 is a schematic illustration of an example processor platform that may be used and/or programmed to carry out the example process of FIG. 12 and/or, more generally, to implement any or all of the example control modules of FIG. 1.

### DETAILED DESCRIPTION

In a process control system it is common for thousands of alarms to be defined within the process control system to notify operators of a process plant of potential problems. However, because alarm settings and/or priorities are commonly defined for a nominal operating state (e.g., when the process plant is producing product), when the process plant is in an alternative operating state (e.g., shut-down, cleaning, maintenance), an excessive number of alarms may be created that have little and/or no meaning or value in the alternative operating state. However, a large number of substantially simultaneous alarms may be confusing to plant operators who may not know and/or not be able to quickly determine which alarms are important and, thus, must to be responded to, and which alarms may be ignored. Unfortunately, if the wrong alarms are ignored, damage to the process plant and/or human injury may occur.

In general, the example apparatus, methods, and articles of manufacture described herein may be used within a process control system to manage process plant alarms. More specifically, the examples described herein utilize one or more flexible, easily definable and/or easily understood alarm behavior data structures (e.g., tables) that define and/or specify the handling of process plant alarms based on operating state (e.g., nominal, maintenance, cleaning, etc.), alarm function (e.g., to protect people and/or equipment, to avoid environmental incidents, and/or to ensure product quality during production) and/or alarm priority (e.g., critical, warning, etc.). Such alarm behavior data structures may be assigned, defined and/or specified for an entire process plant and/or for any portion(s) of the process plant. For example, alarm behavior data structures may be hierarchically managed, defined and/or assigned such that child equipment adopts its alarm behavior data structure from its parent unless a specific alarm behavior data structure has been defined for, specified for and/or assigned to the child.

As described herein, the use of alarm behavior data structures facilitates the definition of alarm handling separately from the implementation of control modules, even while the control modules remain responsible for carrying out and/or processing their respective alarms. Thus, alarm handling functions and/or routines need not be implemented for each control module for each operating state of the process plant, as is commonly performed for known process control systems. Additionally, alarm behavior data structures may be modified, replaced and/or defined without a need to (re-)download one or more control modules of the process plant. For example, a control module may employ a pointer and/or reference to an alarm behavior data structure defined elsewhere in the process plant.

Further, the apparatus, methods, and articles of manufacture described herein assign alarm functions (e.g., to protect people and/or equipment, to avoid environmental incidents, and/or to ensure product quality during production) to alarms. As described, the assignment of alarm functions to alarms simplifies the definition, assignment and/or specification of process plant alarm handling. In particular, the example alarm behavior data structures define for each combination of operating state, alarm function and/or alarm priority how the control modules should process their alarms. For example, when a unit of a process plant is shutdown, any alarms having a critical priority that are defined to protect equipment can remain active while other alarms assigned to other alarm functions (e.g., product quality alarms) may be disabled. Also, as illustrated below, the example alarm behavior data structures are manageable in size and/or easily understood and, thus, the alarm handling for an entire process plant and/or any portion(s) of the process plant may be readily visualized and/or comprehended. In contrast, known process control systems rely on many large and/or cumbersome tables that require the definition of the handling of each alarm (e.g., potentially thousands) for each operating state.

The example alarm behavior data structures described herein may further be used to control, change and/or adjust alarm parameters (e.g., pressure threshold used to trigger a pressure alarm) based on operating state. For example, a first pressure threshold may be used during normal plant operation, while a second pressure threshold is used during a cleaning operation. Because, alarm parameters may be defined within the same data structure(s) use to define alarm handling, the example alarm behavior data structures and/or the example methods to use the same described herein provide more easily understood and/or more easily defined alarm management for process plants than is provided in known process control systems.

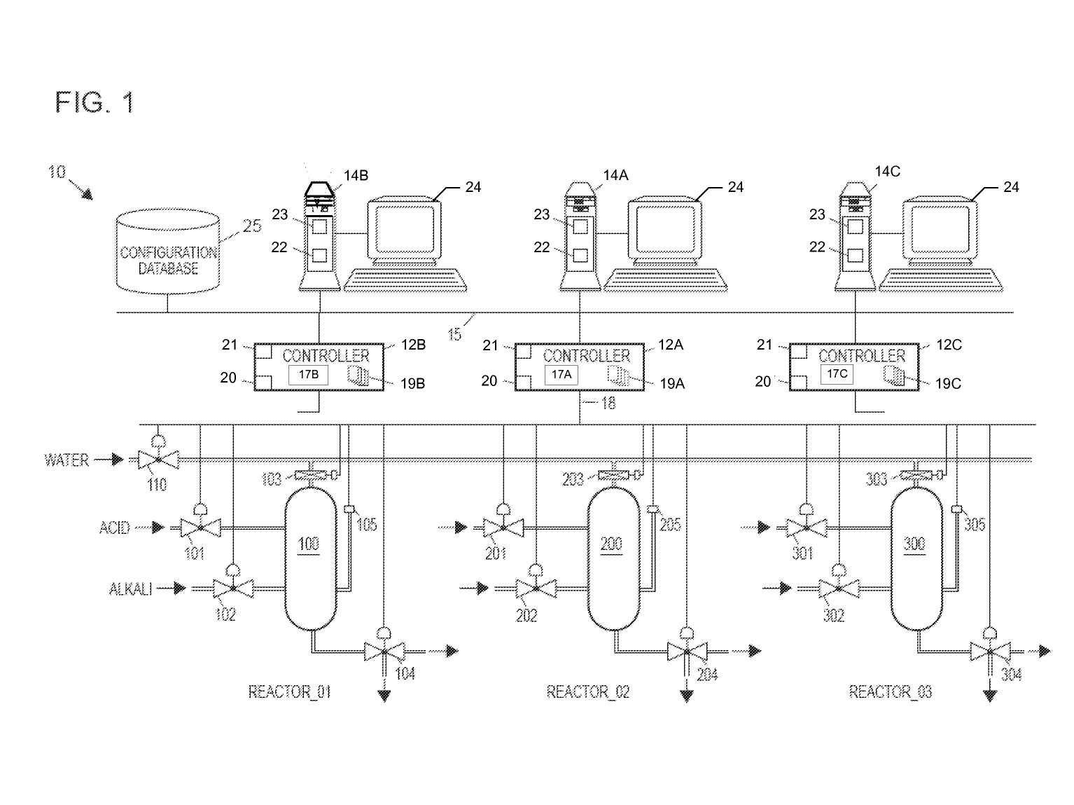

FIG. 1 is a schematic illustration of an example process plant 10. The example process plant 10 of FIG. 1 includes any variety of process controllers, three of which are illustrated in FIG. 1 with reference numerals 12A, 12B and 12C. The example process controllers 12A-C of FIG. 1 are communicatively coupled to any variety of workstations, three of which are illustrated in FIG. 1 with reference numerals 14A, 14B and 14C via any of a variety of communication path(s), bus(es) and/or network(s) 15 such as, for example, an Ethernet-based local area network (LAN).

To control at least a portion of the example process plant 10, the example controller 12A of FIG. 1 is communicatively coupled to any variety of device(s) and/or equipment within the example process plant 10 via any of a variety and/or combination of communication lines or buses 18 such as, for example, a communication bus 18 implemented, constructed and/or operated in accordance with a prevailing Fieldbus protocol. While not illustrated in FIG. 1, persons of ordinary skill in the art will readily recognize that the example process controllers 12B and 12C may likewise be communicatively coupled to the same, alternative and/or additional equipment and/or devices of the example process plant 10. In some example process plants, the controllers 12A-C are DeltaV™ controllers sold by Fisher-Rosemount Systems, Inc., an Emerson Process Management company.

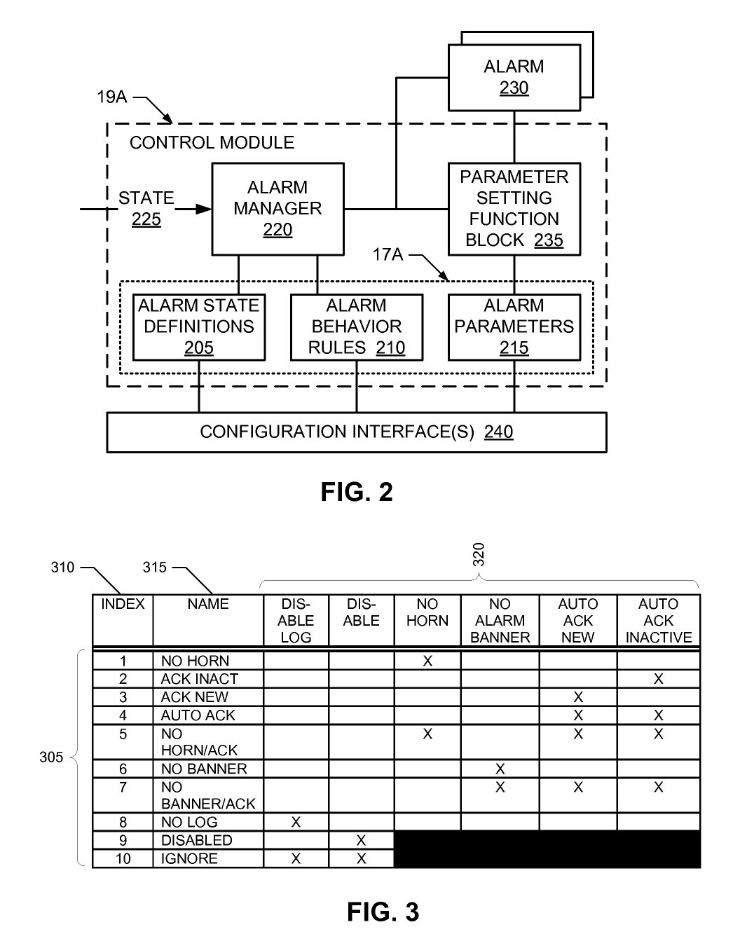

The example process controllers 12A, 12B and 12C of FIG. 1 are capable of communicating with control elements, such as field devices and/or function blocks within field devices distributed throughout the example process plant 10 to execute and/or carry-out one or more associated process control modules 19A, 19B and 19C, respectively, to implement a desired control configuration and/or process for the process plant 10. As described below in connection with FIG. 2, a particular control module 19A-C may, additionally or alternatively, perform alarm management based on one or more alarm behavior data structures 17A-C and/or based on the current operating state of the portion(s) of the process plant 10 controlled the control module 19A-C. In the example process plant 10 of FIG. 1, even though the alarm behavior data structures 17A-C are defined separately from the control modules 19A-C, the control modules 19A-C are responsible for the processing of their alarms. The control modules 19A-C may access and/or utilize a respective alarm behavior data structure 17A-C, and/or one or more of the control modules 19A-C may access and/or utilize a shared and/or common alarm behavior data structure 17A-C. For example, if the process plant 10 is currently is in a shut-down operating state, the alarm behavior data structures 17A-C may specify that all alarms associated with product quality are disabled and, thus, ignored and/or not reported to plant operators. In the example process control system 10 of FIG. 1, the alarm behavior data structures 17A-C are tabular data structures. By using tabular alarm behavior data structures 17A-C to define the handling of process plant alarms based on alarm functions and/or alarm priorities, the control modules 19A-C can more flexibly handle process plant alarms based upon the operating state without a configuration engineer having to explicitly develop alarm handling routines for each control module 19A-C and for each operating state. In particular, the alarm behavior data structures 17A-C define for each combination of operating state, alarm function and/or alarm priority how the control modules 19A-C should process their alarms. For example, even when a unit of the process plant 10 is shutdown, any alarms having a critical priority that are defined to protect equipment can remain active while other alarms (e.g., product quality alarms) may be disabled. Moreover, the example tabular alarm behavior data structures 17A-C provide an intuitive, easily understood and/or utilized format to specify and/or review how alarms are handled in the process plant 10.

While the following descriptions refer to the performance of alarm management by one or more of the example control modules 19A-C, persons of ordinary skill in the art will readily appreciate that any other element(s) of the example process plant 10 of FIG. 1 (e.g., smart field devices such as Fieldbus and/or HART devices) may, additionally or alternatively, perform alarm management.

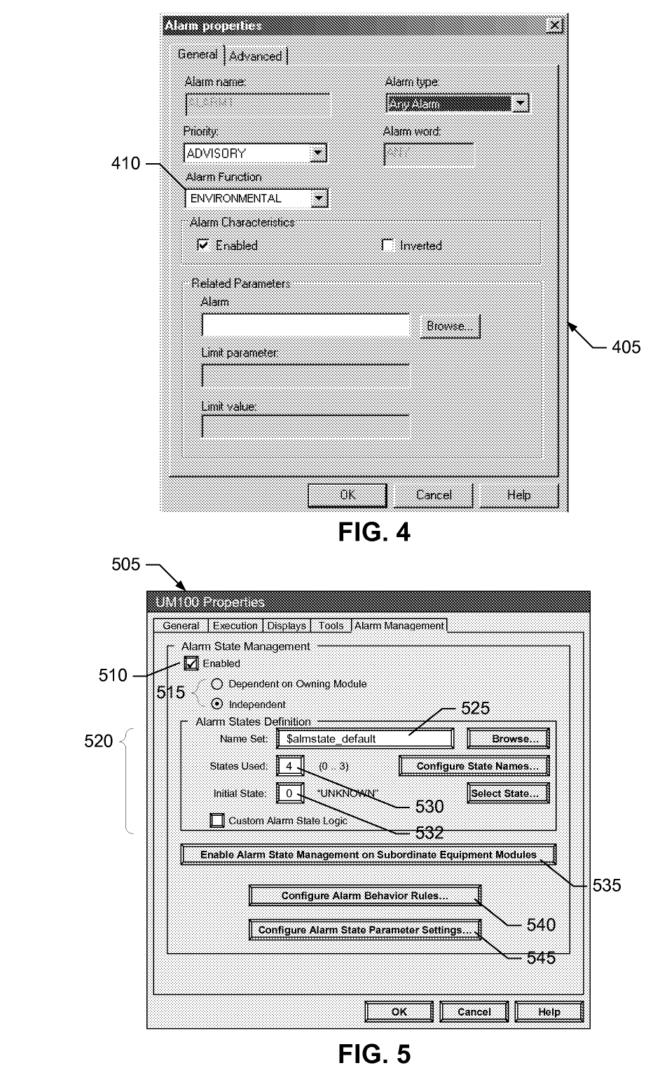

To facilitate the handling of process plant alarms by the example control modules 19A-C, each alarm is assigned an alarm function that represents the purpose of the alarm, for example, to protect people and/or equipment, to avoid environmental incidents, and/or to ensure product quality during production. In the illustrated example of FIG. 1, if a particular alarm is managed as described herein but has not been assigned an alarm function, the alarm will have a default alarm function of unclassified. Each alarm is also configured with a priority (e.g., critical or warning) that defines how important the alarm is relative to other alarms. Each alarm may also be configured with one or more settings and/or parameters (e.g., an alarm limit) that define when a problem has occurred and/or that triggers the alarm. An example interface that may be used to configure an alarm with an alarm function is described below in connection with FIG. 4.

The example alarm behavior data structures 17A-C of FIG. 1 are configured and/or defined by a configuration application (not shown) (e.g., executing on one of the example workstations 14A-C) and then downloaded to the controller(s) 12A-C separate from, together with, and/or as a part of the control modules 19A-C. Example manners of implementing alarm behavior data structures 17A-C, and/or any or all of the example control modules 19A-C of FIG. 1 are described below in connection with FIG. 2.

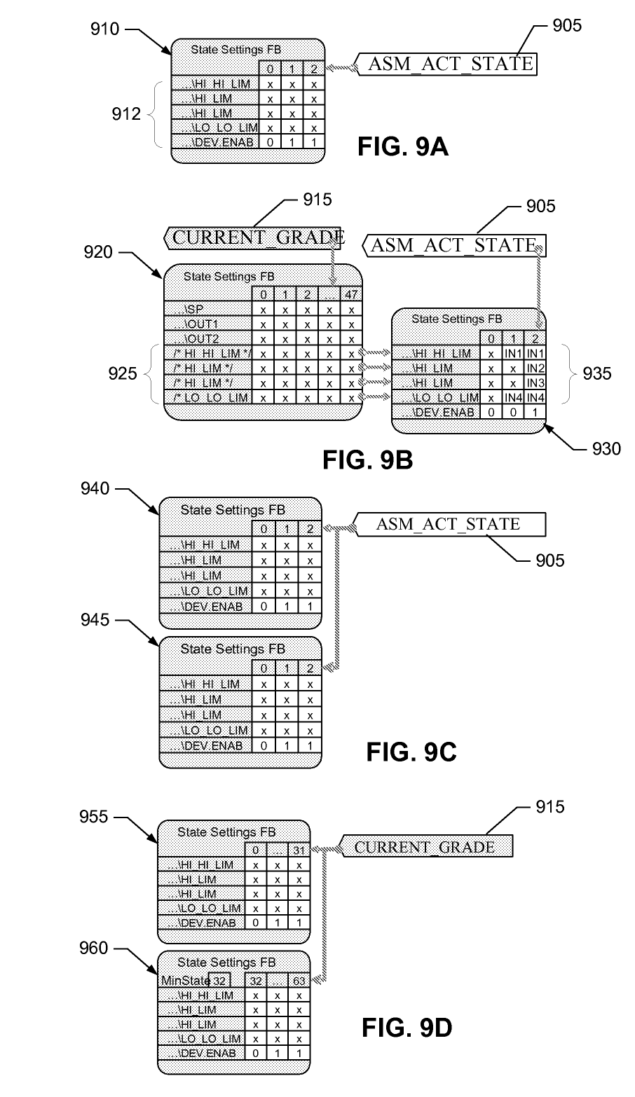

The example process control modules 19A-C of FIG. 1 include and/or implement what are referred to herein as function blocks. As used herein, a function block is all of or any portion of an overall control routine (possibly operating in conjunction with other function blocks via communications links) used to implement process control loops within the example process plant 10. For instance, a parameter setting function block described below in connection with FIGS. 9A-D may be used to set alarm parameters based on an alarm state. A parameter setting function block may also be used to set other types of control system parameters, such as those associated with a control routine.

In some examples, functions blocks are objects of an object-oriented programming protocol that perform any of (a) an input function, such as that associated with a transmitter, a sensor and/or other process parameter measurement device, (b) a control function, such as that associated with a control routine that performs PID, fuzzy logic, etc. control, and/or (c) an output function that controls the operation of some device, such as a valve, to perform some physical function within the process plant 10. Of course, hybrid and/or other types of complex function blocks exist such as model predictive controllers (MPCs), optimizers, etc. While the Fieldbus protocols and/or the DeltaV system protocol use control modules 19A-C and/or function blocks that are designed and/or implemented via an object-oriented programming protocol, the example control modules 19A-C of FIG. 1 could be designed using any of a variety of control programming schemes including, for example, sequential function blocks, ladder logic, etc. and are not limited to designs using function blocks and/or any particular programming technique and/or language.

To store the example process control modules 19A-C and/or alarm behavior data structures 17A-C, each of the example process controllers 12A-C of FIG. 1 includes any number and/or type(s) of data stores 20. The example alarm behavior data structures 17A-C of FIG. 1 may be stored within the data stores 20 as a part of and/or separate from the control modules 19A-C. In addition to storing the process control modules 19A-C, the example data stores 20 of FIG. 1 may be used to store any number and/or type(s) of additional and/or alternative control and/or communications applications used to facilitate communication with the workstations 14A-C and/or control elements of the example process plant 10. Example data stores 20 include any number and/or type(s) of volatile (e.g., random-access memory (RAM)) and/or non-volatile (e.g., FLASH, read-only memory (ROM) and/or a hard-disk drive) data storage element(s), device(s) and/or unit(s).

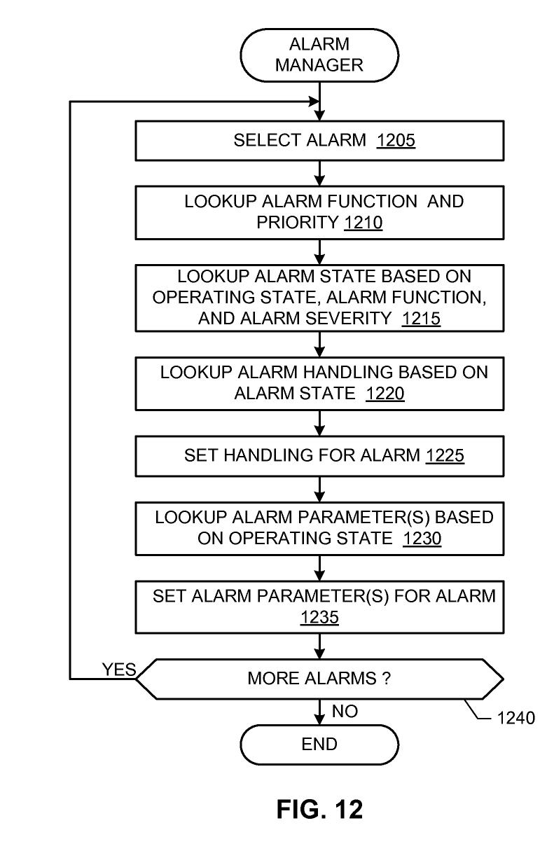

To execute and/or carryout the process control modules 19A-C, alarm management and/or function blocks, each of the example process controllers 12A-C of FIG. 1 includes any number and/or type(s) of processors 21. The example processors 21 of FIG. 1 may be any type of processing unit, such as a processor core, processor and/or microcontroller capable to execute, among other things, machine accessible instructions that implement the example process of FIG. 12.

The example workstations 14A-C of FIG. 1 may be implemented using any type(s) of personal computer(s) and/or computer workstation(s). The example workstations 14A-C of FIG. 1 may be used by, for example, one or more configuration engineers to design and/or configure the example process control modules 19A-C that are to be executed by the example controllers 12A-C. The workstations 14A-C of the illustrated example can, additionally or alternatively, be used to design and/or configure alarm management for the process plant 10 and/or, more specifically, to view, define, configure and/or modify the alarm behavior data structures 17A-C utilized by the control modules 19A-C to perform alarm management. The workstations 14A-C of the illustrated example can, additionally or alternatively, be used to design and/or configure display routines to be executed by the workstations 14A-C and/or other computers. Further, the example workstations 14A-C can, additionally or alternatively, communicate with the controllers 12A-C to provide and/or download the alarm behavior data structures 17A-C and/or the process control modules 19A-C to the controllers 12A-C. The example workstations 14A-C can, additionally or alternatively, execute display routines that receive and/or display information pertaining to the example process plant 10 (e.g., alarms), its elements and/or sub-elements during operation of the process plant 10. Moreover, the example workstations 14A-C may be used to set and/or configure operating states for all or any portion(s) of the example process plant 10.

To store applications, such as configuration design applications, display applications, and/or viewing applications, and/or for storing data, such as configuration data pertaining to the configuration of the example process plant 10, each of the example workstations 14A-C of FIG. 1 includes any number and/or type(s) of stores or memories 22. The example stores 22 of FIG. 1 may be any number and/or type(s) of volatile (e.g., RAM) and/or non-volatile (e.g., FLASH, ROM, and/or hard-disk drive) data storage element(s), device(s) and/or unit(s).

To execute the applications that, for example, enable a configuration engineer to design process control routines and/or other routines, to download these process control routines to the example controllers 12A-C and/or to other computers, and/or to collect and/or display information to a user during operation of the process plant 10, each of the example workstations 14A-C of FIG. 1 includes any number and/or type(s) of processors 23. The example processors 23 of FIG. 1 may be any type of processing unit, such as a processor core, processor and/or microcontroller capable to execute, among other things, machine accessible instructions, code, software, firmware, etc.

The example workstations 14A-C of FIG. 1 can provide a graphical depiction of the process control modules 19A-C associated with the example controllers 12A-C to a user via any number and/or type(s) of display screens 24 that illustrates the control elements within the process control modules 19A-C and/or the manner in which these control elements are configured to provide control of the process plant 10. To store configuration data used by the process controllers 12A-C and/or the workstations 14A-C (e.g., the alarm behavior data structures 17A-C), the example system of FIG. 1 includes a configuration database 25. The example configuration database 25 of FIG. 1 is communicatively coupled to the controllers 12A-C and the workstations 14A-C via the example Ethernet-based LAN 15. The example configuration database 25 of FIG. 1 also serves as a data historian to collect and/or store data generated by and/or within the process plant 10 for future use and/or recall.

In the illustrated example of FIG. 1, the process controller 12A is communicatively coupled via the example bus 18 to three similarly configured reactors referred to herein as REACTOR_01, REACTOR_02 and REACTOR_03. However, the process controller 12 could have been communicatively coupled to any number and/or type(s) of additional and/or alternative process plant equipment that may be used to produce and/or output any variety of products.

To provide a master control for controlling the flow of water to each of the reactors, the example process plant 10 of FIG. 1 includes a shared header valve system 110 that is connected on the water line upstream of each of the example reactors REACTOR_01, REACTOR_02 and REACTOR_03.

The example REACTOR_01 of FIG. 1 includes any variety of reactor vessel or tank 100, three input valve systems (i.e., equipment entities) 101, 102 and 103 connected to control fluid inlet lines providing acid, alkali and water, respectively, to the reactor vessel 100, and an outlet valve system 104 connected to control fluid flow(s) out of the reactor vessel 100. A sensor 105, which can be any desired type of sensor, such as a level sensor, a temperature sensor, a pressure sensor, etc., is disposed in and/or near the example reactor vessel 100. In the illustrated example of FIG. 1, the sensor 105 is a level sensor.

Similarly, the example REACTOR_02 of FIG. 1 includes a reactor vessel 200, three input valve systems 201, 202 and 203, an outlet valve system 204, and a level sensor 205. Likewise, the example REACTOR_03 of FIG. 1 includes a reactor vessel 300, three input valve systems 301, 302 and 303, an outlet valve system 304, and a level sensor 305.

Persons of ordinary skill in the art will readily appreciate that the example process plant 10 and/or, more particularly, the example reactors REACTOR_01, REACTOR_02 and/or REACTOR_03 may be used to produce and/or output any variety of products. For example, the reactors REACTOR_01, REACTOR_02 and/or REACTOR_03 can produce salt with the example input valve systems 101, 201 and 301 providing acid, the example input valve systems 102, 202 and 302 providing alkali and the example input valve systems 103, 203 and 303, in conjunction with the shared water header 110, providing water to the reactor vessels 100, 200 and 300. The outlet valve systems 104, 204 and 304 may be operated to send product out of flow lines directed to the right of each of the reactors REACTOR_01, REACTOR_02 and/or REACTOR_03 in FIG. 1 and/or to drain waste or other unwanted material out of a flow lines directed towards the bottom in FIG. 1.

In the example process plant 10 of FIG. 1, the example controller 12A is communicatively coupled to the valve systems 101, 102, 104, 110, 201, 202, 204, 301, 302 and 304 and to the sensors 105, 205 and 305 via the bus 18 to control the operation(s) of these elements to perform one or more processing operations with respect to the example reactor units REACTOR_01, REACTOR_02 and REACTOR_03. Such operations, commonly referred to as phases, may include, for example, filling the example reactor vessels 100, 200, 300, heating the material within the reactor vessels 100, 200, 300, dumping the reactor vessels 100, 200, 300, cleaning the reactor vessels 100, 200, 300, etc. The example controller 12A (more specifically a control module 19A) may also utilize inputs from the sensors 105, 205, and 305 and/or any other sensors (not shown) to determine when conditions warranting an alarm occur (e.g., temperature in the reactor tank 100 exceeds a predetermined threshold). Moreover, one or more of the control modules 19A may implement alarm management to configure alarm parameters (e.g., a threshold) and/or to handle alarms based upon the operating state of the process plant 10 and/or any portion(s) of the process plant 10 being controlled. In particular, as described below in connection with FIG. 2, the control modules 19A use one or more configurable alarm behavior data structures 17A-C and/or the current operating state to manage alarms within the process plant 10.

The example valves, sensors and other equipment 101, 102, 104, 105, 201, 202, 204, 205, 301, 302, 304 and 305 illustrated in FIG. 1 may be any variety of equipment including, but not limited to, Fieldbus devices, standard 4-20 milliamp (mA) devices and/or HART devices, and may communicate with the example controller 12A using any of a variety of communication protocol(s) and/or technology(-ies) such as, but not limited to, the Fieldbus protocol, the HART protocol, and/or the 4-20 mA analog protocol. Other types of devices may, additionally or alternatively, be coupled to and/or controlled by the controllers 12A-C in accordance with the principles discussed herein.

While an example process plant 10 has been illustrated in FIG. 1, the controllers 12A-C, workstations 14A-C, buses 15 and 18, control devices, etc. illustrated in FIG. 1 may be divided, combined, re-arranged, eliminated and/or implemented in any of a variety of ways. Further, the example process plant 10 may include any variety of additional and/or alternative controllers, workstations, buses, control devices than those illustrated in FIG. 1 and/or may include more or fewer than the number of controllers, workstations, buses, control devices illustrated in FIG. 1. For example, a process plant may include any number of controllers and/or workstations.

Further, a process plant may include any of a variety of process entities instead of and/or in addition to the example reactors illustrated in FIG. 1. Further still, a process plant may produce of a variety of products using any of a variety of processes. Accordingly, persons of ordinary skill in the art will readily appreciate that the example process plant 10 of FIG. 1 is merely illustrative. Still further, a process plant may include and/or encompass one or more geographic locations including, for example, one or more buildings within and/or nearby a particular geographic location.

FIG. 2 illustrates an example manner of implementing any or all of the example control modules 19A-C of FIG. 1. While any of the control modules 19A-C of FIG. 1 may be represented by the example of FIG. 2, for ease of discussion, the illustration of FIG. 2 will be referred to as control module 19A. To define the handling of alarms, the example alarm behavior data structure 17A of FIG. 2 includes alarm state definitions 205, alarm behavior rules 210 and alarm parameter values 215. However, any or all the example alarm state definitions 205, the example alarm behavior rules 210 and/or the example alarm parameter values 215 may be omitted and/or replaced with, for example, a pointer or other reference to a data structure stored and/or implemented elsewhere.

The example alarm state definitions 205 of FIG. 2 is implemented as a tabular data structure that defines, for a set of alarm states, how a process plant alarm is to be reported, logged and/or handled. That is, a lookup based on an alarm state (e.g., ignore, disabled, no horn or acknowledge, etc.) can be performed on the alarm state definitions 205 to obtain one or more alarm handling behaviors for the alarm state (e.g., disable logging, alarm disabled, no horn, no alarm banner, automatically acknowledge new alarm, automatic acknowledge inactive, etc.). An example data structure that may be used to implement the example alarm state definitions 205 of FIG. 2 is described below in connection with FIG. 3.

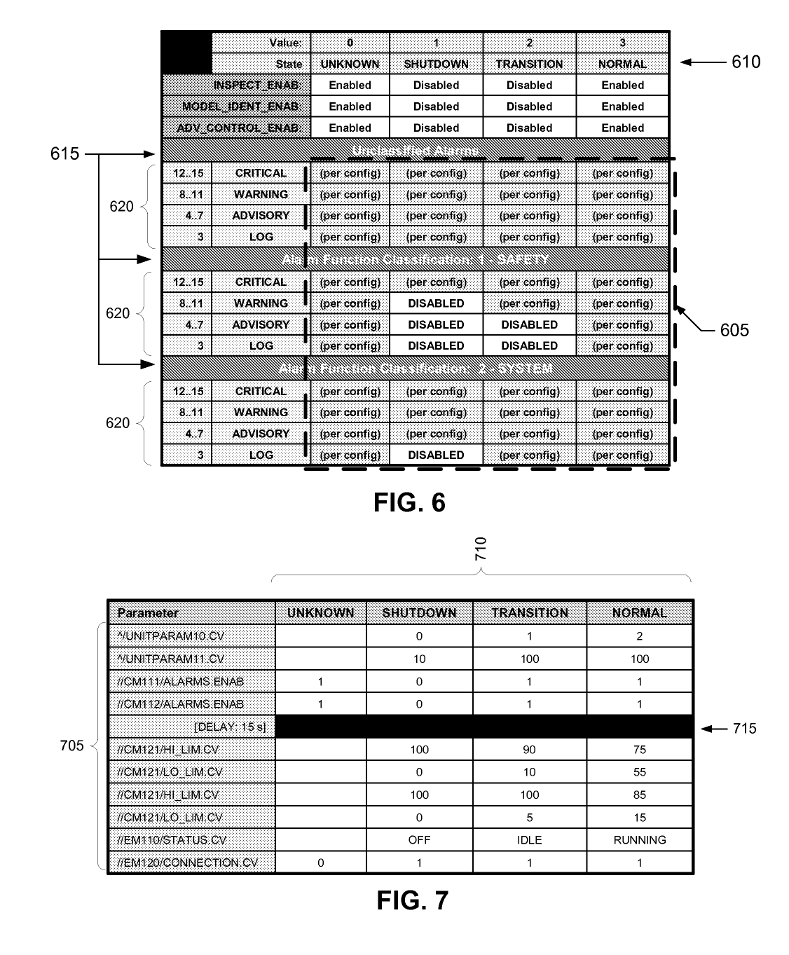

The example alarm behavior rules 210 of FIG. 2. is implemented as a tabular data structure that defines an alarm state (e.g., ignore, disabled, no horn or acknowledge, etc.) for various combinations of operating state, alarm function and alarm priority. That is, a lookup based on an operating state, alarm function and alarm priority can be performed on the alarm behavior rules 210 to obtain an alarm state. An example data structure that may be used to implement the example alarm behavior rules 210 of FIG. 2 is described below in connection with FIG. 6.

The example alarm parameters 215 of FIG. 2. is also implemented as a tabular data structure that defines, for a set of operating states, one or more alarm parameters (e.g., thresholds). That is, a lookup based on an operating state can be performed on the alarm parameters 215 to obtain the alarm parameters. An example data structure that may be used to implement the example alarm parameters 215 of FIG. 2 is described below in connection with FIG. 7.

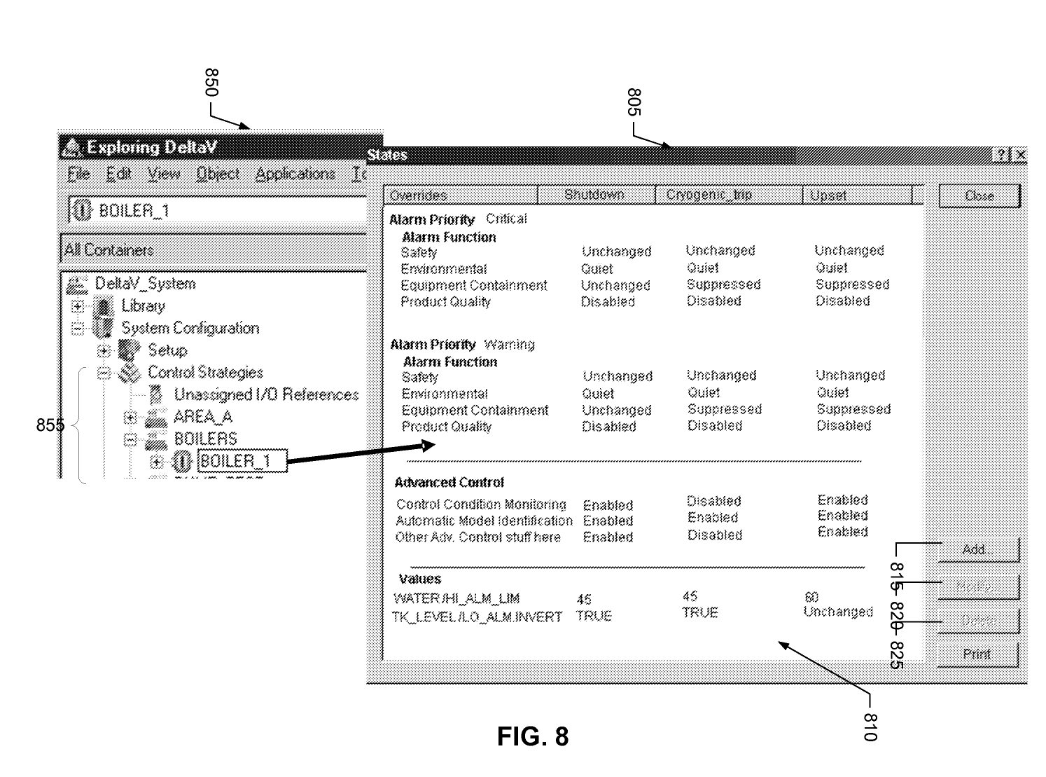

While the example alarm state definitions 205, the example alarm behavior rules 210 and the example alarm parameters 215 are shown as separate data structures in the illustrated example of FIG. 2, they may be implemented as any number of data structures. For example, as illustrated in FIG. 8, the alarm behavior rules 210 and the alarm parameters 215 may be implemented as a single tabular data structure. Moreover, while the example alarm state definitions 205, the example alarm behavior rules 210 and the example alarm parameters 215 of FIG. 2 are implemented using tables, they may be implemented using any number and/or type(s) of additional and/or alternative data structures formats.

The example data structures 205, 210 and 215 of FIG. 2 may be tailored for and/or be unique to a particular control module 19A, and/or may be inherited from a parent entity as part of a hierarchical and/or object-based configuration methodology. For example, all entities of a unit module may automatically utilize and/or reference the same data structures 205, 210 and 215 defined for a corresponding unit module object class, unless they are explicitly re-defined and/or re-configured for a particular control module 19A-C and/or for a particular set of control modules 19A-C. Example methods for configuring a set of module objects for process control systems are described in U.S. Pat. No. 7,043,311, entitled “Module Class Objects in a Process Plant Configuration System”; and U.S. patent application Ser. No. 11/537,138, entitled “Methods and Module Class Objects to Configure Equipment Absences in Process Plants,” and filed on Sep. 29, 2006. U.S. Pat. No. 7,043,311 and U.S. patent application Ser. No. 11/537,138 are each hereby incorporated by reference in their entireties. Methods and apparatus for configuring process plants are described in U.S. Pat. No. 6,385,496, entitled “Indirect Referencing in Process Control System,” which is hereby incorporated by reference in its entirety.

To handle alarms, the example control module 19A of FIG. 2 includes an alarm manager 220. Based on a received operating state indication and/or instruction 225 (e.g., received from one of the example workstations 14A-C of FIG. 1 and/or an owning control module 19A-C), the example alarm manager 220 of FIG. 2 configures the handling of one or more alarms 230. For a particular alarm 230, the example alarm manager 220 looks up an alarm state for the alarm 230 based on the received operating state 225 and the alarm function assigned to the alarm 230. The alarm manager 220 then obtains the alarm handling behavior(s) (e.g., disable logging, alarm disabled, no horn, no alarm banner, automatically acknowledge new alarm, automatic acknowledge inactive, etc.) for the obtained alarm state by performing a lookup of the alarm state definitions 205. Based upon the alarm handling behavior(s) obtained from the alarm state definitions 205, the example alarm manager 220 configures the handling of the alarm 230. For example, if the alarm 230 is to be disabled, the alarm manager 220 disables the alarm 230.

To set alarm parameters (e.g., thresholds, etc.), the example control module 19A of FIG. 2 includes a parameter setting function block 235. For a received operating state 225, the example parameter setting function block 235 of FIG. 2 performs a lookup of the example alarm parameters 215 to obtain one or more alarm parameters. The example parameter setting function block 235 then programs or otherwise configures the obtained alarm parameters to their corresponding alarm(s) 230. Example operations of the example parameter setting function block 235 of FIG. 2 are described below in connection with FIGS. 9A-D.

To configure the alarm behavior data structures 205, 210 and/or 215, one or more configuration interfaces 240 may be implemented by, for example, one or more of the example workstations 14A-C of FIG. 1. For example, the example user interface of FIG. 4 may be used to configure an alarm function for an alarm 230, the example user interface of FIG. 5 may be used to enable alarm handling and/or to select alarm behavior rules 210, the example user interface of FIG. 8 may be used to view, configure and/or modify alarm behavior rules 210 and/or alarm parameters 215.

While an example manner of implementing any or all of the example control modules 19A-C of FIG. 1 has been illustrated in FIG. 2, the data structures, elements, processes and devices illustrated in FIG. 2 may be combined, divided, re-arranged, omitted, eliminated and/or implemented in any of a variety of ways. Further, the example alarm manager 220, the example parameter setting function block 235, the example alarm behavior data structures 205, 210 and 215, the example configuration interfaces 240 and/or, more generally, the example control module 19A of FIG. 2 may be implemented by hardware, software, firmware and/or any combination of hardware, software and/or firmware. Further still, the example control module 19A may include additional elements, processes and/or devices than those illustrated in FIG. 2 and/or may include more than one of any or all of the illustrated data structures, elements, processes and devices.

FIG. 3 illustrates an example data structure that may be used to implement the example alarm state definitions 205 of FIG. 2. The example data structure of FIG. 3 has a plurality of entries 305 for respective ones of a plurality of alarm states. In general, each of the plurality of entries 305 specifies one or more alarm handling behaviors 320 for each alarm state 305.

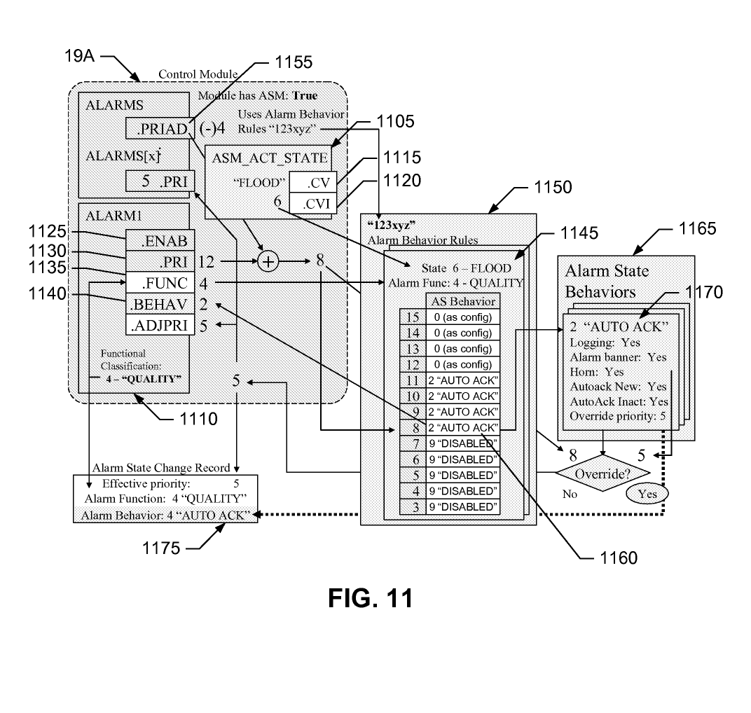

To identify an alarm state, each of the example entries 305 of FIG. 3 includes an index field 310. The example index field 310 of FIG. 3 includes a value that uniquely identifies the alarm state. For example, as illustrated in FIG. 11, integer state values may be used to facilitate efficient communication of an alarm state and/or to enable efficient logic and/or handling of an alarm state. For example, logic could be performed on an alarm state value 310 to, for example, distinguish the presentation of the alarm (e.g., color coding), emphasize the presentation of the alarm (e.g., bold borders and/or blinking text), and/or diminish the presentation of the alarm (e.g., visibility and/or opacity).

To further identify an alarm state, each of the example entries 305 of FIG. 3 includes a name field 315. The example name field 315 of FIG. 3 includes an alphanumeric string that represents a name for the alarm state.

To specify alarm handling behaviors, each of the example entries 305 of FIG. 3 includes a plurality of flag fields 320 for respective ones of a plurality of alarm handling behaviors. Each of the example flag fields 320 of FIG. 3 contains a binary valued flag (e.g., X=TRUE or blank=FALSE) that represents whether the corresponding alarm handling behavior is active for the alarm state. For example, for the example “NO HORN” alarm state illustrated in FIG. 3, the no horn flag field 320 contains an X indicating that no horn is to be sounded if an alarm having an alarm state of “NO HORN” occurs.

While an example data structure is illustrated in FIG. 3, the example data structure may be implemented using any number and/or type(s) of other and/or additional fields and/or data. Further, the fields and/or data illustrated in FIG. 3 may be combined, divided, omitted, re-arranged, eliminated and/or implemented in any of a variety of ways. For example, the number and/or classification(s) of the example entries 305 and/or 320 may be different from those shown in FIG. 3. Moreover, the example data structure may include additional fields and/or data than those illustrated in FIG. 3 and/or may include more than one of any or all of the illustrated fields and/or data.

FIG. 4 illustrates an example user interface 405 that may be used to configure an alarm function for a process plant alarm. To configure the alarm function for an alarm, the example user interface 405 of FIG. 4 includes a drop-down selection box 410 that allows a user of the example user interface 405 to select an alarm function from a list of alarm functions (not shown). An alarm that has not had an alarm function assigned to it may be assumed to have a default alarm function, such as UNCLASSIFIED.

FIG. 5 illustrates an example user interface 505 that may be used to enable alarm management and/or to define a set of alarm behavior rules (e.g., the example alarm behavior rules 210 of FIG. 2) for a process entity. To enable alarm management, the example user interface 505 of FIG. 5 includes a check box 510. When the example check box 510 of FIG. 1 is selected (e.g., contains a √ or X), alarm management for the process entity is enabled.

To specify whether alarm management is dependent upon an owning module (e.g., a parent), the example user interface 505 of FIG. 5 includes one or more check boxes 515. The example check boxes 515 of FIG. 5 permit a user of the example user interface 505 to specify whether alarm management will be defined independently from its owning module or dependent upon the owning module.

If alarm management is defined independently, then alarm state definition entry elements 520 are activated for use. To identify a name for the alarm behavior rules, the example elements 520 of FIG. 5 include a text box 525. The example text box 525 of FIG. 5 allows a user of the example user interface 505 of FIG. 5 to, if they choose, enter and/or type a name to replace a default name of “$almstate_default.” To specify the number of alarm states, the example elements 520 of FIG. 5 include another text box 530. A user of the user interface 505 may enter a number in the text box 530 to specify the number of alarm states for the module (e.g., four). Likewise, a text box 532 is provided to allow the user to specify a number corresponding to an initial and/or default alarm state (e.g., zero).

To enable alarm state management for subordinate equipment modules, the example user interface 505 of FIG. 5 includes a button 535. Pressing the example button 535 of FIG. 5 enables alarm management for subordinate (i.e., owned) equipment modules.

To configure alarm behavior rules, the example user interface 505 of FIG. 5 includes a button 540. The example button 540 of FIG. 5 initiates another user interface (e.g., the example user interface of FIG. 6) that allows a user of that user interface to view, enter, configure, modify and/or define a table of alarm behavior rules for various combinations of operating state, alarm priority and alarm function (e.g., the example alarm behavior rules 210 of FIG. 2).

To configure alarm parameters, the example user interface 505 of FIG. 5 includes a button 545. The example button 545 of FIG. 5 initiates yet another user interface (e.g., the example user interface of FIG. 7) that allows a user of that user interface to view, enter, configure, modify and/or define a table of alarm parameters for various operating states (e.g., the example alarm parameters 215 of FIG. 2).

While example user interfaces 405 and 505 are illustrated in FIGS. 4 and 5, the example user interfaces 405 and 505 may be implemented using any number and/or type(s) of other and/or additional user interface elements. Further, the user interface elements illustrated in FIGS. 4 and 5 may be combined, divided, omitted, re-arranged, eliminated and/or implemented in any of a variety of ways. Moreover, the example user interfaces 405 and/or 505 may include additional or fewer user interface elements than those illustrated in FIGS. 4 and/or 5 and/or may include more than one of any or all of the illustrated user interface elements.

FIG. 6 illustrates an example data structure that may be used to implement the example alarm behavior rules 210 of FIG. 2. The example data structure of FIG. 6 contains a plurality of entries 605 for respective ones of a plurality of combinations of processing state 610, alarm function 615 (e.g., unclassified, safety, system, etc.) and alarm priority 620 (e.g., log, advisory, warning, critical, etc.). A particular entry 605 specifies an alarm state for the corresponding combination of processing state 610, alarm function and alarm priority 620. In the illustrated example of FIG. 6, an entry 605 of “(per config)” is used to indicate that the handling of the alarm is as defined by the control module 19A-C (i.e., default). Entries 605 containing other values (e.g., one of the example name values 315 of FIG. 3) specifies an alarm state other than the default alarm handling state.

FIG. 7 illustrates an example data structure that may be used to implement the example alarm parameters 215 of FIG. 2. The example data structure of FIG. 7 contains a plurality of entries 705 for respective ones of a plurality of alarm parameters (e.g., thresholds). To specify an alarm parameter value for each of a plurality of operating states, each of the example entries 705 of FIG. 7 includes a plurality of value fields 710. Each of the example value fields 710 of FIG. 7 contains a value and/or alphanumeric string that represents a value that an alarm parameter is to be set to for the corresponding operating state. For example, the alarm parameter “̂UNITPARAM10.CV” is to be set to a value of one for the “TRANSITION” operating state.

As illustrated in FIG. 7, one or more delay entries 705 (e.g., an entry 715) may be present in an alarms parameter data structure. The example delay entry 715 defines a time delay between setting the alarm parameters 705 specified above the delay entry 715 and setting the alarm parameters 705 specified below the delay entry 715. The insertion of delay entries 705 allows a configuration engineer to properly sequence and/or coordinate the setting of alarm parameters (e.g., delaying making an alarm more sensitive after an operating state change). For example, a first parameter is set 15 seconds after a second parameter has been set.

While example data structures have been illustrated in FIGS. 6 and 7, the example data structures may be implemented using any number and/or type(s) of other and/or additional fields and/or data. Further, the fields and/or data illustrated in FIGS. 6 and 7 may be combined, divided, omitted, re-arranged, eliminated and/or implemented in any of a variety of ways. For example, the number and/or classification(s) of the example entries 605, 705 and/or 710 may be different from those shown in FIGS. 6 and/or 7. Additionally or alternatively, the example data structures illustrated in FIGS. 6 and 7 may be implemented as a single data structure (e.g., the example data structure 810 illustrated in FIG. 8). Moreover, the example data structures may include additional or fewer fields and/or data than those illustrated in FIGS. 6 and/or 7 and/or may include more than one of any or all of the illustrated fields and/or data.

FIG. 8 illustrates an example user interface 805 that may be used to view, configure and/or modify an alarm behavior data structure 810. The example data structure 810 of FIG. 8 implements both alarm behavior rules (e.g., the example alarm behavior rules 210 of FIGS. 2 and/or 6) and alarm parameters (e.g., the example alarm parameters 215 of FIGS. 2 and/or 7).

To allow a user to add an alarm behavior rule and/or alarm parameter, the example user interface 805 of FIG. 8 includes an Add button 815. The example Add button 815 of FIG. 8 initiates another user interface (not shown) that allows the user to specify, configure and/or define an additional alarm behavior rule and/or set of alarm parameter values.

To allow a user to modify an alarm behavior rule and/or alarm parameter, the example user interface 805 of FIG. 8 includes a Modify button 820. When a particular and/or a set of alarm behavior rules and/or alarm parameters are selected (i.e., a selected entry) and when the example Modify button 820 is pressed, another user interface (e.g., a dialog box) (not shown) is initiated that allows the user to enter, modify and/or select one or more new values for the selected entry. Likewise, a Delete button 825 allows the user to delete a selected entry.

FIG. 8 also illustrates another example user interface 850 that allows a user to browse a list of control modules 855. The example user interface 850 of FIG. 8 is based on the DeltaV Explorer and allows a user to select a particular control modules 855 (e.g., “BOILER_1”) and then initiate the example user interface 805 to view, configure and/or modify alarm behavior rules and/or alarm parameters for the particular control module 855.

While example user interfaces 805 and 850 are illustrated in FIG. 8, the example user interfaces 805 and/or 850 may be implemented using any number and/or type(s) of other and/or additional user interface elements. Further, the user interface elements illustrated in FIG. 8 may be combined, divided, omitted, re-arranged, eliminated and/or implemented in any of a variety of ways. Moreover, the example user interfaces 805 and/or 850 may include additional user interface elements than those illustrated in FIG. 8 and/or may include more than one of any or all of the illustrated user interface elements.

FIGS. 9A, 9B, 9C and 9D illustrate example operations of a parameter setting function block (e.g., the example parameter setting function block 235 of FIG. 2). For example, as illustrated in FIG. 9A, a parameter setting function block performs a table lookup of a table 910 based upon an input parameter 905 (e.g., an alarm state and/or an operating state). Based upon the input parameter 905, the parameter setting function block obtains a value for each of a plurality of parameters 912, and then sets each of the parameters 912 to the corresponding obtained value from the table 910.

FIG. 9B illustrates an example parameter setting function block operation involving two input parameters 905 and 915. The use of the second input 905 allows for parameter values to be varying input values rather than fixed constants, that is the value of a parameter value (e.g., IN1, IN2, IN3 and/or IN4) varies depending upon the value of the second input 905. The parameter setting function block operation of FIG. 9B also illustrates an example “ganging” of parameter setting function blocks. In particular, a subordinate table 920 presents values chosen based on its input parameter 915 to an overriding table 930 that uses its own input parameter 905 to make the final value selection. In the illustrated example of FIG. 9B, a first table 920 is index based upon the input parameter 915 CURRENT_GRADE and contains references 925 to a second table 930. The parameter setting function block uses the second input 905 to index the second table 930 to obtain the parameter values 935 corresponding to the two input parameters 905 and 915.

In some examples, a table used by a parameter setting function block may be limited in the number of sets of parameters values (i.e., number of rows) that may be represented (e.g., thirty-two). Thus, as illustrated in FIG. 9C, a parameter setting function block may utilize two parameter value tables 940 and 945, thereby extending the number of parameters that are set based upon a single input 905.

In some examples, a table used by a parameter setting function block may be limited in the range of input values (i.e., number of columns) that may be represented (e.g., thirty-two). Thus, as illustrated in FIG. 9D, a parameter setting function block may reference two parameter value tables 955 and 960 (concatenate them together), thereby extending the range of input values supported by the parameter setting function block.

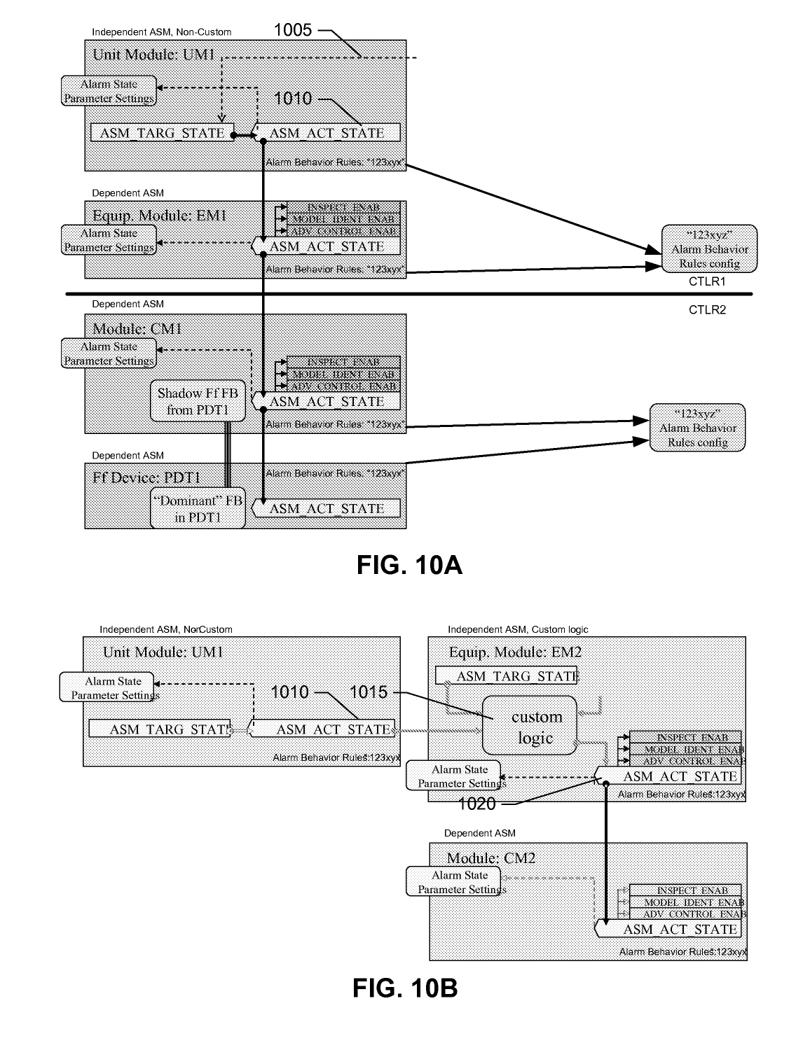

FIG. 10A illustrates an alarm handling example for the example process plant 10 of FIG. 1. In the illustrated example of FIG. 10A, a unit module UM1 receives an input 1005 initiating a change in the operating state of the unit module UM1. In response to the input 1005, the example unit module UM1 of FIG. 10A changes the active operating state 1010 of the unit module UM1 in accordance with the input 1005, and then performs alarm handling configuration for its alarms based upon the new operating state 1010 (e.g., by determining and configuring one or more alarm states and/or by determining and setting one or more alarm parameters).

The example unit module UM1 of FIG. 10A also drives the new operating state 1010 to a dependent equipment module EM1. The example equipment module EM1 of FIG. 10A performs alarm handling configuration for its alarms based upon the new operating state 1010 (e.g., by determining and configuring one or more alarm states and/or by determining and setting one or more alarm parameters). As illustrated in FIG. 10A, the new operating state 1010 and corresponding alarm handling configuration changes are successively driven by the dependent equipment module EM1 to each dependent process entity (e.g., a dependent module CM1, a dependent Fieldbus device PDT1)

FIG. 10B illustrates another alarm handling example for the example process plant 10 of FIG. 1. In the illustrated example of FIG. 10B, the unit module UM1 drives the new operating state 1010 to an independent equipment module EM2, and then performs alarm handling configuration for its alarms based upon the new operating state 1010 (e.g., by determining and configuring one or more alarm states and/or by determining and setting one or more alarm parameters). The example EM2 of FIG. 10B may apply additional logic 1015 to the operating state 1010 to determine an operating state 1020 for the EM2 and its dependent module CM2. The example equipment module EM2 of FIG. 10B and its dependent module CM2 perform alarm handling configuration for their alarms based upon the new operating state 1020 (e.g., by determining and configuring one or more alarm states and/or by determining and setting one or more alarm parameters).

FIG. 11 illustrates another example manner of implementing any or all of the example control modules 19A-C of FIG. 1. While any of the control modules 19A-C of FIG. 1 may be represented by the example of FIG. 11, for ease of discussion, the illustration of FIG. 11 will be referred to as control module 19A.

Based upon an operating state 1105, the example control module 19A of FIG. 11 performs alarm handling configuration for a plurality of alarms, one of which is illustrated in FIG. 11 with reference number 1110. The example operating state 1105 of FIG. 11 is implemented as a data structure containing a name 1115 (e.g., FLOOD) and an integer 1120 (e.g., six). Likewise, the example alarm 1110 is implemented as a data structure containing a flag 1125 indicating whether alarm management is enabled, an integer 1130 that represents the priority of the alarm 1110 and, another integer 1135 that represents the alarm function of the alarm 1110, and yet another integer 1140 that represents the alarm state for the alarm 1110.

Based upon the operating state integer 1120 and the alarm function integer 1135, the control module 19A identifies a portion 1145 of an alarm behaviors data structure 1150. Based upon the priority integer 1130 (possibly modified by a priority adjustment 1155), the control module 19A identifies the alarm state 1160 (e.g., “AUTO ACK”) for the alarm 1110. Then, based on the identified alarm state 1160, the control module 19A performs a lookup of an alarm state behaviors data structure 1170 to identify and then configure the alarm handling for the alarm 1110 and the operating state 1105. As illustrated in FIG. 11, the alarm handling changes may be recorded in an alarm state change record 1175 for later retrieval and/or review.

While an example manner of implementing any or all of the example control modules 19A-C of FIG. 1 has been illustrated in FIG. 11, the data structures, elements, processes and devices illustrated in FIG. 11 may be combined, divided, re-arranged, omitted, eliminated and/or implemented in any of a variety of ways. Further, any or all of the example control module 19A, and/or the data structures 1150,1165 and 1175 may be implemented by hardware, software, firmware and/or any combination of hardware, software and/or firmware. Further still, the example control module 19A may include additional or fewer elements, processes and/or devices than those illustrated in FIG. 11 and/or may include more than one of any or all of the illustrated data structures, elements, processes and devices.

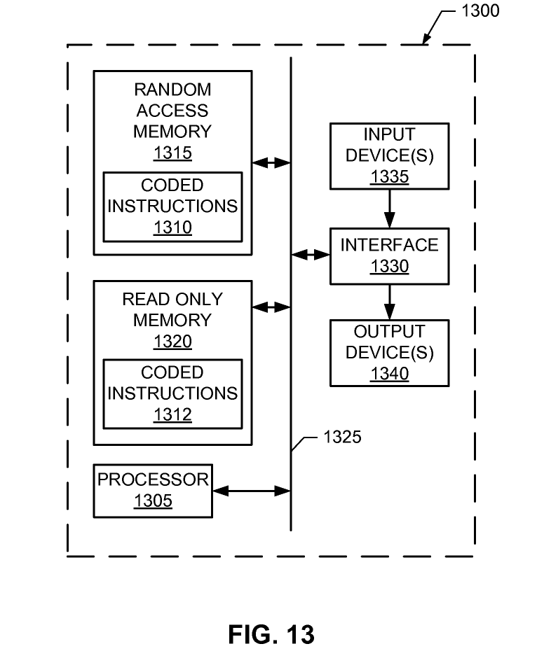

FIG. 12 is a flowchart representative of an example process that may be carried out to implement the example alarm manager 220 of FIG. 2 and/or, more generally, any or all of the example control modules 19A-C described herein. The example process of FIG. 12 may be carried out by a processor, a controller and/or any other suitable processing device. For example, the example process of FIG. 12 may be embodied in coded instructions stored on a tangible machine accessible or readable medium such as a flash memory, a ROM and/or random-access memory RAM associated with a processor (e.g., the example processor 1305 discussed below in connection with FIG. 13). Alternatively, some or all of the example process of FIG. 12 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, one or more of the operations depicted in FIG. 12 may be implemented manually or as any combination of any of the foregoing techniques, for example, any combination of firmware, software, discrete logic and/or hardware. Further, although the example process of FIG. 12 is described with reference to the flowchart of FIG. 12, persons of ordinary skill in the art will readily appreciate that many other methods of implementing the example process of FIG. 12 may be employed. For example, the order of execution of the blocks may be changed, and/or some of the blocks described may be changed, eliminated, sub-divided, or combined. Additionally, persons of ordinary skill in the art will appreciate that any or all of the example process of FIG. 12 may be carried out sequentially and/or carried out in parallel by, for example, separate processing threads, processors, devices, discrete logic, circuits, etc.

The example process of FIG. 12 begins when an alarm manager (e.g., the example alarm manager 220 of FIG. 2) and/or, more generally, a control module (e.g., any or all of the example control modules 19A-C described herein) is notified of a new operating state. The alarm manager selects a first process plant alarm from the set of process plant alarms managed by the alarm manager (block 1205). The alarm manager then looks up the alarm function and priority assigned to the process plant alarm (block 1210).

The alarm manager performs a data structure query (e.g., performs a table lookup in an alarm behavioral rules table) based on the operating state, the alarm function and the alarm priority to obtain an alarm state for the alarm (block 1215). The alarm manager then performs a second data structure query (e.g., performs a table lookup in an alarm state definitions table) based on the alarm state to obtain alarm handling information for the alarm (block 1220).

The alarm handler configures the handling of the alarm (block 1225) and performs a third data structure query (e.g., performs a table lookup in an alarm parameters table) based on the operating state to obtain any number (including zero) of alarm parameters that need to be set (block 1230). The alarm handler configures any obtained alarm parameters (block 1235). If there are more alarms to be managed (block 1240), control returns to block 1205 to process the next alarm. If there are no more alarms to be managed (block 1240), control exits from the example process of FIG. 12.

FIG. 13 is a schematic diagram of an example processor platform 1300 that may be used and/or programmed to implement any or all of the example alarm manager 220, the example parameter setting function block 235, the example configuration interfaces 240, the example user interfaces 405, 505, 805 and 850, the example control modules 19A-C, the example controllers 12A-C and/or the example workstations 14A-C described herein. For example, the processor platform 1300 can be implemented by one or more general purpose processors, processor cores, microcontrollers, etc.

The processor platform 1300 of the example of FIG. 13 includes at least one general purpose programmable processor 1305. The processor 1305 executes coded instructions 1310 and/or 1312 present in main memory of the processor 1305 (e.g., within a RAM 1315 and/or a ROM 1320). The processor 1305 may be any type of processing unit, such as a processor core, a processor and/or a microcontroller. The processor 1305 may execute, among other things, the example process of FIG. 12 to implement the example alarm manager 220 described herein. The processor 1305 is in communication with the main memory (including a ROM 1320 and/or the RAM 1315) via a bus 1325. The RAM 1315 may be implemented by DRAM, SDRAM, and/or any other type of RAM device, and ROM may be implemented by flash memory and/or any other desired type of memory device. Access to the memory 1315 and 1320 may be controlled by a memory controller (not shown). The RAM 1315 may be used to store and/or implement, for example, the example alarm behavior data structures 17A-C, the example alarm state definitions 205, the example alarm behavior rules 210, and/or the alarm parameters 215.

The processor platform 1300 also includes an interface circuit 1330. The interface circuit 1330 may be implemented by any type of interface standard, such as a USB interface, a Bluetooth interface, an external memory interface, serial port, general purpose input/output, etc. One or more input devices 1335 and one or more output devices 1340 are connected to the interface circuit 1330. The input devices 1335 and/or output devices 1340 may be used to receive the example operating state input 225 and/or to configure the example alarms 230 of FIG. 2.

Although certain example methods, apparatus and articles of manufacture have been described herein, the scope of coverage of this patent is not limited thereto. Such example are intended to be non-limiting illustrative examples. On the contrary, this patent covers all methods, apparatus and articles of manufacture fairly falling within the scope of the appended claims either literally or under the doctrine of equivalents.

1. A method comprising:
receiving a process plant control system configuration parameter, the process plant control system configuration parameter representing a selected state of a process plant;
performing a first query in an alarm definition data structure based on the process plant control system configuration parameter to obtain an alarm configuration parameter for a process plant alarm module of a process plant controller; and
configuring a state of the process plant alarm module based on the obtained alarm configuration parameter.

2. A method as defined in claim 1, further comprising:
performing a second query in the alarm definition data structure to obtain a variable representative of an alarm state behavior for the process plant alarm module, the variable representing a configured action of the process plant alarm module in response to a measurable variable of the process plant; and
configuring an operation of the process plant alarm module based on the obtained variable.

3. A method as defined in claim 2, wherein the second query in the alarm definition data structure comprises performing a table lookup based on the obtained alarm configuration parameter.

4. A method as defined in claim 2, further comprising:
performing a third query in the alarm definition data structure to obtain an alarm threshold; and
configuring the operation of the process plant alarm module based on the obtained alarm threshold.

5. A method as defined in claim 1, wherein the alarm configuration parameter comprises at least one of a logging disabled state, an alarm disabled state, a no horn state, a no alarm banner state, an automatic acknowledge state, or an automatic acknowledge inactive state.

6. A method as defined in claim 1, wherein configuring the state of the process plant alarm module comprises configuring a parameter associated with the process plant alarm module.

7. A method as defined in claim 1, wherein the first query in the alarm definition data structure comprises performing a table lookup based on the process plant control system configuration parameter.

8. A tangible article of manufacture storing machine readable instructions that, when executed, cause a machine to:
receive a process plant control system configuration parameter, the process plant control system configuration parameter representing a selected state of a process plant;
perform a first query in an alarm definition data structure based on the process plant control system configuration parameter to obtain an alarm configuration parameter for a process plant alarm module of a process plant controller; and
configure a state of the process plant alarm module based on the obtained alarm configuration parameter.

9. A tangible article of manufacture as defined in claim 8, wherein the machine readable instructions, when executed, cause the machine to:
perform a second query in the alarm definition data structure to obtain a variable representative of an alarm state behavior for the process plant alarm module, the variable representing a configured action of the process plant alarm module in response to a measurable variable of the process plant; and
configure an operation of the process plant alarm module based on the obtained variable.

10. A tangible article of manufacture as defined in claim 9, wherein the machine readable instructions, when executed, cause the machine to:
perform a third query in the alarm definition data structure to obtain an alarm threshold; and
configure the operation of the process plant alarm module based on the obtained alarm threshold.

11. A tangible article of manufacture as defined in claim 8, wherein the alarm configuration parameter comprises at least one of a logging disabled state, an alarm disabled state, a no horn state, a no alarm banner state, an automatic acknowledge state, or an automatic acknowledge inactive state.

12. A tangible article of manufacture as defined in claim 8, wherein the machine readable instructions, when executed, cause the machine to configure the state of the process plant alarm module by configuring a parameter of the process plant alarm module.

13. A tangible article of manufacture as defined in claim 8, wherein the machine readable instructions, when executed, cause the machine to perform the first query in the alarm definition data structure by performing a table lookup based on the process plant control system configuration parameter.

14. An apparatus comprising:
a tangible machine accessible memory;
an alarm behavior rules data structure stored on the machine accessible memory, the alarm behavior rules data structure defining, for a process plant alarm module of a process plant controller, a plurality of alarm configuration parameters for respective ones of a plurality of process plant control system configuration parameters; and
an alarm manager to receive a variable representative of a selected state of a process plant, to obtain an alarm configuration parameter from the alarm behavior rules data structure based on the received variable, and to configure the process plant alarm module based on the obtained alarm configuration parameter.

15. An apparatus as defined in claim 14, wherein the alarm configuration parameter comprises at least one of an alarm behavior state, an action in response to a measurable variable of the process plant, or an alarm threshold.

16. An apparatus as defined in claim 14, wherein the alarm parameter data structure is stored on the tangible machine accessible memory.

17. An apparatus as defined in claim 14, wherein the alarm behavior rules data structure comprises a tabular data structure, wherein the alarm manager is to obtain the alarm configuration parameter by performing a lookup of the tabular data structure based on the variable representative of the selected state of the process plant.

18-41. (canceled)
